(19) United States
(12) Patent Application Publication
(10) Pub. No.: US 2026/0328956 A1
(43) Pub. Date: Oct. 22, 2026

(54) METHODS AND SYSTEMS FOR ENHANCING COMPUTATIONAL EFFICIENCY OF WAVE EQUATION BASED SIMULATIONS USING QUANTIZED TENSOR TRAINS

(71) Applicant: BP Corporation North America Inc., Houston, TX (US)

(72) Inventors: Mikhail Davydenko, Houston, TX (US); Vladimir Bashkardin, Katy, TX (US)

(73) Assignee: BP Corporation North America Inc., Houston, TX (US)

(21) Appl. No.: 19/529,057

(22) Filed: Feb. 3, 2026

Related U.S. Application Data
(60) Provisional application No. 63/755,902, filed on Feb. 7, 2025.

(51) Int. Cl. G01V 1/28; G01V 1/34

(52) U.S. Cl. CPC G01V 1/282; G01V 1/345; G01V 2210/675

(57) ABSTRACT

A method for enhancing computational efficiency of a wave equation based simulation, the method comprising: generating at least one subsurface model based at least in part on initial seismic data associated with a subsurface region; compressing the at least one subsurface model and the initial seismic data into one or more quantized tensor train (QTT) objects, wherein the one or more QTT objects comprises a QTT subsurface model representing the at least one subsurface model and QTT seismic data representing the initial seismic data; performing, in a QTT domain, the wave equation simulation based on the QTT subsurface model and the QTT seismic data; and generating one or more images of the subsurface region based on the wave equation simulation performed in the QTT domain.

### CROSS-REFERENCE TO RELATED APPLICATIONS

The present application claims priority to U.S. Provisional Application No. 63/755,902 filed on Feb. 7, 2025, and entitled, “METHODS AND SYSTEMS FOR ENHANCING COMPUTATIONAL EFFICIENCY OF WAVE EQUATION BASED SIMULATIONS USING QUANTIZED TENSOR TRAINS,” which is hereby incorporated herein by reference in its entirety.

### BACKGROUND

Seismic surveying is a geophysical technique used to investigate the subsurface structure of the Earth by sending shock waves or vibrations into the ground and analyzing the reflected waves. Seismic waves are reflected when they encounter boundaries between different layers of subsurface materials, such as rock, sediment, or fluid. These layers have different densities, which cause the seismic waves to change speed and direction upon encountering the boundary. When a seismic wave propagates through the Earth and strikes a boundary between materials of different densities, a part of the seismic wave energy is transmitted into the new layer and the remainder is reflected back toward the surface. The reflected seismic wave energy is observed at the surface as observed seismic data and may be studied to ascertain information about the subsurface region. For example, the observed seismic data may be used to construct one or more seismic attributes of the subsurface region such as a velocity model of the subsurface region which models the velocity of the seismic waves passing through the subsurface region so as to translate subsurface reflection points of the seismic waves to their true depth within the formation. Furthermore, the seismic data observed by the receivers may also be used to create other seismic attributes such as an image or profile of the corresponding subsurface region. Interpretation of these seismic images may provide a description of composition, density, and depth of subsurface materials and aids in resource extraction, hazard assessment, and environmental impact studies of the subsurface.

### SUMMARY

In an embodiment, a method for enhancing computational efficiency of a wave equation-based simulation is disclosed. The method comprises: (a) generating at least one subsurface model based at least in part on initial seismic data associated with a subsurface region; (b) compressing the at least one subsurface model and the initial seismic data into one or more quantized tensor train (QTT) objects, wherein the one or more QTT objects comprises a QTT subsurface model representing the at least one subsurface model and QTT seismic data representing the initial seismic data; (c) performing, in a QTT domain, the wave equation simulation based on the QTT subsurface model and the QTT seismic data; and (d) generating one or more images of the subsurface region based on the wave equation simulation performed in the QTT domain. In another embodiment, (c) comprises: (c1) determining, in the QTT domain, one or more gradients using the QTT subsurface model and the QTT seismic data; (c2) iteratively updating, in the QTT domain, the QTT subsurface model using the one or more gradients; (c3) determining, in the QTT domain, residual data by comparing synthetic data produced by the QTT subsurface model with the QTT seismic data; and (c4) migrating, in the QTT domain, the residual data backwards through time to determine the one or more gradients. In one embodiment, the method further comprises forward modeling, in the QTT domain, the QTT subsurface model to generate the synthetic data. In some other embodiment, (d) comprises: (d1) selecting a final QTT subsurface model based on a predefined threshold; and (d2) generating one or more images of the subsurface region using the final QTT subsurface model. In one other embodiment, the method further comprises (e) recompressing the one or more QTT objects by rounding computed values at each computational step based on the initial seismic data. In some other embodiments, (d2) comprises decompressing the final QTT subsurface model to generate the one or more images of the subsurface region in full domain. In yet another embodiment, time domain computations comprise solving the wave equation using explicit finite-difference time-stepping method with the QTT seismic data. In another embodiment, frequency domain computations comprise solving the wave equation using an implicit finite-difference method to solve a sparse system of equations defined directly in the QTT domain. In another embodiment, the wave equation comprises acoustic wave equation, elastic wave equation, and anisotropic extensions thereof. In an embodiment, a system comprising: a storage device configured to store instructions; and one or more processors coupled to the storage device, wherein when executed by the one or more processors, the instructions cause the system to: (a) generate at least one subsurface model based at least in part on initial seismic data associated with a subsurface region; (b) compress the at least one subsurface model and the initial seismic data into one or more QTT objects, wherein the one or more QTT objects comprises a QTT subsurface model representing the at least one subsurface model and QTT seismic data representing the initial seismic data; (c) perform, in a QTT domain, a wave equation simulation based on the QTT subsurface model and the QTT seismic data; and (d) generate one or more images of the subsurface region based on the wave equation simulation performed in the QTT domain. In another embodiment, when executed by the one or more processors, further cause the system to: (c1) determine, in the QTT domain, one or more gradients using the QTT subsurface model and the QTT seismic data; (c2) iteratively update, in the QTT domain, the QTT subsurface model using the one or more gradients; (c3) determine, in the QTT domain, residual data by comparing synthetic data produced by the QTT subsurface model with the QTT seismic data; and (c4) migrate, in the QTT domain, the residual data backwards through time to determine the one or more gradients. In another embodiment, the instructions, when executed by the one or more processors, further cause the system to forward model, in the QTT domain, the QTT subsurface model to generate the synthetic data. In another embodiment, the instructions, when executed by the one or more processors, further cause the system to: (d1) select a final QTT subsurface model based on a predefined threshold; and (d2) generate one or more images of the subsurface region using the final QTT subsurface model. In some other embodiments, the instructions, when executed by the one or more processors, further cause the system to: (e) recompress the one or more QTT objects by rounding computed values at each computational step based on the initial seismic data. In yet another embodiment, (d2) comprises decompressing the final QTT subsurface model to generate the one or more images of the subsurface region in full domain. In another embodiment, the instructions, when executed by the one or more processors further cause the system to perform time domain computations by solving a wave equation using an explicit finite-difference time-stepping method with the QTT seismic data. In another embodiment, the instructions, when executed by the one or more processors further cause the system to perform frequency domain computations by solving the wave equation using an implicit finite-difference method to solve a sparse system of equations defined directly in the QTT domain. In another embodiment, the wave equation comprises acoustic wave equation, elastic wave equation, and anisotropic extensions thereof. In embodiment, a computer program product comprising computer-executable instructions that are stored on a non-transitory computer-readable medium and that, when executed by one or more processors, cause a computing system to: (a) generating at least one subsurface model based at least in part on initial seismic data associated with a subsurface region; (b) compressing the at least one subsurface model and the initial seismic data into one or more QTT objects, wherein the one or more QTT objects comprises a QTT subsurface model representing the at least one subsurface model and QTT seismic data representing the initial seismic data; (c) performing, in a QTT domain, the wave equation simulation based on the QTT subsurface model and the QTT seismic data; and (d) generating one or more images of the subsurface region based on the wave equation simulation performed in the QTT domain. In another embodiment, when executed by the one or more processors, further cause the computing system to (e) recompress the one or more QTT objects by rounding computed values at each computational step based on the initial seismic data.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system according to various embodiments disclosed herein;

FIG. 2 is a schematic diagram of an embodiment of a system for performing a marine seismic survey according to various embodiments disclosed herein;

FIG. 3 is a schematic diagram of an embodiment of a system for performing a land-based seismic survey according to various embodiments disclosed herein;

FIG. 4 is a block diagram of an embodiment of a computer system that may perform operations described herein based on data acquired via the marine survey system of FIG. 2 and/or the land survey systems of FIG. 3 according to various embodiments described herein;

FIG. 5 is a graphical representation of QTT forward modeling in time domain according to various embodiments described herein;

FIG. 6 is a flowchart of a method for time domain forward modeling using QTT according to various embodiments described herein;

FIG. 7 is a flowchart of a method for RTM using quantized tensor trains according to various embodiments described herein;

FIG. 8 is a flowchart of a method for hybrid RTM combining QTT domain and full domain operations according to various embodiments described herein;

FIG. 9 is a flowchart of a method for frequency domain forward modeling using QTT according to various embodiments described herein;

FIG. 10 is a flowchart of an embodiment of a method for enhancing computational efficiency of wave equation based simulation according to various embodiments described herein;

FIGS. 11A-11C illustrate comparison results for a central slice of 3D model, showing full domain wavefield, QTT wavefield, and timestep runtime comparisons according to various embodiments described herein;

FIGS. 12A-12C illustrate comparison results for a larger central slice of 3D model, showing full domain wavefield, QTT wavefield, and timestep runtime comparisons according to various embodiments described herein;

FIGS. 13A-13C illustrate frequency domain modeling results, showing velocity model, real part of full domain wavefield, and real part of QTT wavefield according to various embodiments described herein; and

FIGS. 14A-14C illustrate 3D imaging results, showing inline slice, crossline slice, and depth slice of the subsurface image according to various embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

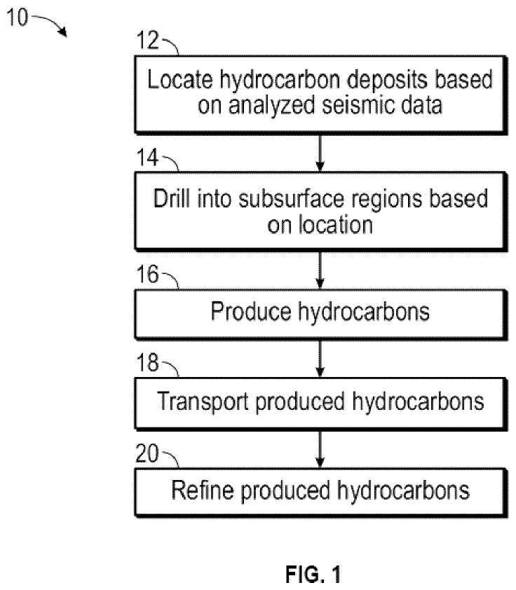

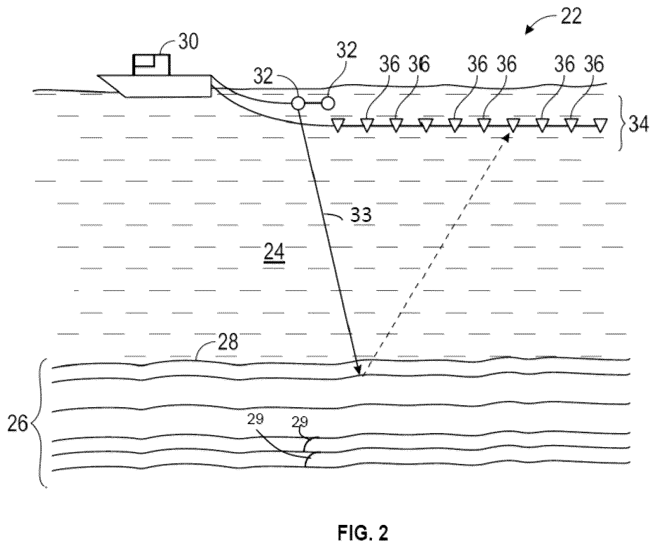

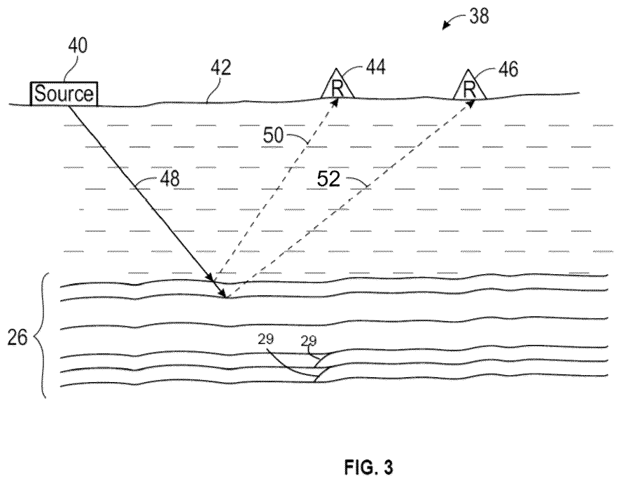

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wellbores, artificial lift wellbores, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

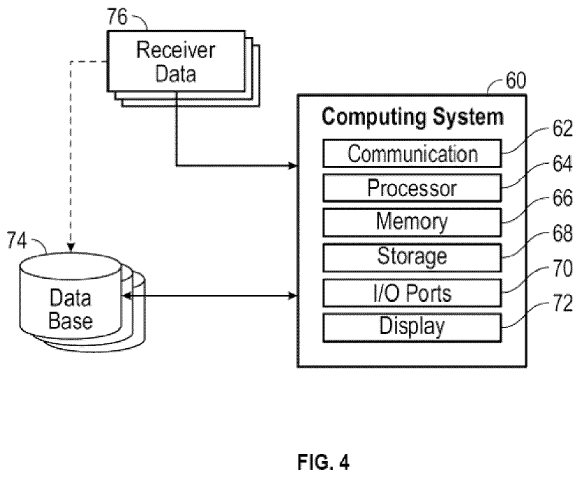

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location, and the properties of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the I/O ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. The processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, I/O modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location, and the properties of hydrocarbon deposits within the subsurface region 26, predictions of seismic properties associated with one or more wellbores in the subsurface region 26, and the like. The display 72 may be any suitable type of display, such as a liquid-crystal display (LCD), plasma display, or an organic light-emitting diode (LED) (or OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at different points in time. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations associated with the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys reflect seismic waves off of features of subsurface regions of the Earth in order to collect information regarding the subsurface regions. The information collected from the reflected seismic waves may be used to create velocity models and seismic images which may be used to identify subterranean features of interest such as, for example, hydrocarbon deposits. A seismic survey may comprise a very large number of individual seismic recordings or traces. As such, a variety of seismic data processing and imaging algorithms may be used to remove noise from the acquired seismic data, migrate the pre-processed seismic data, identify shifts between multiple seismic images, align multiple seismic images, and the like. However, conventional seismic data processing and imaging techniques may encounter various challenges that compromise cost, time, and efficiency. As an example, in some applications an iterative data-fitting process such as a full waveform inversion (FWI) process may be applied to the collected seismic data to form a velocity model therefrom, which may be used in, for example, reverse time migration (RTM) to generate an image of the subsurface. Both FWI and RTM involve solving the wave equation multiple times, making both methods expensive and computationally demanding, especially when handling three-dimensions (3D) surveys and/or complex subsurface models.

FWI is an iterative technique for modeling subsurface regions where seismic data collected from seismic receivers may be compared with modeled waveforms and the model may be subsequently adjusted to minimize misfit until modeled waveforms closely match observed data across different frequencies and arrival times. RTM may be a process for creating subsurface images using a velocity model (such as one created by FWI) and recorded seismic data, where source wavefields may be computed by migrating modeled source wavefields forward using the forward wave equation while receiver wavefields may be computed by migrating recorded seismic data backwards in time to a point of reflection, and RTM may include convolving with an imaging condition to generate the subsurface image. However, both methods may be computationally expensive and resource-intensive: RTM may involve solving the wave equation twice for each shot and saving entire wavefield solutions at each time step during forward and backward propagation, while FWI may use wavefield simulations and model updates with each iteration involving running the wave equation numerous times, and using full domain seismic data in these methods may be particularly inefficient as the large volume of data significantly increases computational demand in terms of storage and processing time.

As indicated above, wave equation based seismic data processing algorithms such as FWI and RTM are highly useful tools for creating detailed subsurface images and velocity models. However, these methods may face significant computational challenges, particularly for large-scale three-dimensional (3D) surveys and complex geological settings. The fundamental challenge may involve the need to solve the wave equation repeatedly across massive data volumes. A single 3D seismic survey may generate terabytes of data, and processing this data may involve storing entire 3D wavefields at each time step during simulation. When an FWI process involves hundreds or thousands of such simulations, and when RTM involves both forward and backward wavefield propagation for numerous source positions, the cumulative computational cost in terms of processing time, memory requirements, and energy consumption becomes prohibitive.

The present disclosure addresses the aforementioned technical problem in the technical field of seismic data analysis and imaging by applying Quantized Tensor Train (QTT) decomposition to wave equation based seismic simulations. In an embodiment, seismic data, velocity models, and computed wavefields may contain significant redundancy. Neighboring points in space often includes similar or smoothly varying values, and this near redundancy state among neighboring points may be exploited for compression. Rather than storing and computing with every individual data point in corresponding original full domain representation, the disclosed systems and methods compress the data into a compact mathematical representation called a Quantized Tensor Train and then perform all computational operations directly on the compressed representation.

In an embodiment, the QTT compression operates in two stages. First, a quantization or reshaping process reorganizes the data structure. For example, a 3D seismic data array of size 2ⁿ×2ⁿ×2ⁿ samples may be reshaped into a higher-dimensional array of size 2×2× . . . ×2 (with 3n dimensions, each of size 2). This reorganization exploits the regular structure of gridded seismic data. Second, a tensor train decomposition represents this reshaped array as a sequence of small interconnected tensors called cores, rather than storing the full array. The relationship between the size of the original data and the size of the tensor train representation determines the compression ratio, which may be substantial for seismic data.

Furthermore, the QTT approach comprises arithmetic and algebraic operations including addition, multiplication, and derivative calculations which may be performed directly on data in QTT form without converting back to full domain representation. The wave equation, whether in time domain or frequency domain formulation, may be solved entirely using QTT objects. For time domain simulations, an explicit finite-difference time-stepping scheme propagates wavefields forward in time, with all operations performed on QTT representations. For frequency domain simulations, the system of equations arising from discretization of the Helmholtz equation may be formulated and solved directly in QTT domain. In some cases, differential operators such as the Laplacian operator, which is central to wave equation solutions, have particularly compact representations in QTT domain, often limited to a rank of 2 regardless of problem size. This compact operator representation provides additional computational advantages when computing spatial derivatives.

To maintain computational efficiency throughout a simulation, the disclosed methods may apply a recompression or rounding procedure after each arithmetic operation. Each addition, multiplication, or other operation on QTT objects may cause the rank of the representation to increase, which may gradually inflate the size of the compressed data and erode computational advantages. By applying tensor train rounding with predefined accuracy and maximum rank parameters after each computational step, the methods keep the QTT representation compact throughout the entire simulation. This allows long time-domain simulations or iterative inversion processes to maintain compression benefits from start to finish.

Computational cost associated with the QTT approach disclosed herein is approximately half that of full domain methods, for example, providing roughly 2× speedup in processing time. Further, approximately 40× compression may be achieved in memory savings for wavefield storage in large 3D models. Meanwhile, the accuracy of QTT-based simulations closely matches that of full domain simulations, indicating that the compression may not introduce errors when appropriate accuracy parameters are selected.

The computational advantages of the QTT approach become more pronounced as problem size increases, making the method particularly valuable for the large-scale, high-resolution simulations that are most computationally challenging using conventional methods. By performing all computational operations directly in the compressed QTT domain, the disclosed methods fundamentally alter how the computer processes and stores seismic data, reducing memory requirements while simultaneously achieving computational speedup of approximately 11-fold or greater for large-scale problems. This compression and acceleration may enable computer systems to execute simulations and process datasets that would otherwise exceed available memory capacity or require impractically long processing times, thereby overcoming previous hardware-imposed limitations on problem size and resolution. The technical improvement to computer functionality is achieved through the QTT transformation's ability to represent multi-dimensional seismic data as computations on smaller tensor cores with controlled rank parameters, allowing operations to be executed on compressed representations rather than requiring the computer to load, process, and store full uncompressed arrays. The disclosed techniques may be applied to complete seismic imaging workflows including, for example, forward modeling, backward modeling, RTM, and FWI, with all operations performed entirely in the QTT domain. The improved computational efficiency may allow to obtain better subsurface images, more accurate velocity models, improve identification of drilling targets, more reliable estimation of hydrocarbon reserves, and reduce exploration risk.

With the foregoing overview in mind, the following sections describe the mathematical foundations and implementation details of the QTT approach. Tensor train (TT), also known as Matrix Product State (MPS), is a form of tensor decomposition that may represents multi-dimensional numerical data arrays (or tensors) as a computation sequence comprised of smaller tensors. The total number of elements in the original tensor may be significantly larger than the total number of elements used to represent the original tensor in TT form, enabling the TT representation to serve as a data compressor. Further, it may be possible to perform arithmetic operations on the original tensors using the TT representation. This enables computing in the TT domain to provide computational advantages due to the reduced number of elements that need to be processed.

The TT decomposition approximates a full d-dimensional tensor a of size n₁×n₂× ... ×n_{d} as a series of tensor contractions. In the quantum physics, this decomposition may be referred to as the MPS, though the mathematical formulation may remain the same. Each dimension k of the original tensor is represented by a tensor train core Gₖ, which is a 3D tensor of size r_{{k-1}}×nₖ×rₖ. The size of Gₖ is determined by rank parameter rₖ and the size of the original k^{th} dimension. The Tensor-Train Singular Value Decomposition (TT-SVD) algorithm computes coefficients of Gₖ using the original tensor A as input and computes an approximation with prescribed accuracy and maximum rank.

TT representation allows arithmetic and algebraic operations to be performed directly in the tensor train domain by manipulating the cores Gₖ. Multiplying an original tensor A by a scalar λ is equivalent to scaling one of the cores by the same value. Summation of two tensors in full domain is equivalent to merging or concatenating cores of the two tensors along the rank dimension. In this case, ranks of the summed tensors are added and thereby increased. Each arithmetic operation may introduce inflation of rank, which may lead to increased computational costs and reduced compression efficiency.

The TT-rounding procedure allows recompression or re-approximation of a tensor that is already in TT-domain by another tensor train with more optimal rank. A threshold on accuracy and maximum rank may be predefined. Practically, TT-rounding is applied after each arithmetic step to keep ranks of the modified tensors small and to maintain algorithm efficiency.

The Quantized Tensor Train (QTT), also known as Quantics Tensor Train, is a special form of TT that leverages reshaping of data prior to TT decomposition. For a 3D volume array, the three physical spatial dimensions may be divided into more but smaller dimensions. As an example, a quantization (or reshaping) process may split a 3D spatial array of 2ⁿ×2ⁿ×2ⁿ samples into a 3n-dimensional array where each dimension has a size of 2. Such reshaping or data reorganization may achieve even more effective TT representation and may provide even more effective and faster computation due to the smaller number of elements needed to represent the original data. QTT formulation may enables benefits from bitwise operations. Moreover, various operators, such as the Laplacian operator, are compact in QTT domain and may be limited to a rank of 2, which provides additional computational advantages for computing derivatives in QTT domain.

The term “full domain” as used herein refers to the computational space or computations in which operations are performed on seismic data in full vector-space that has not been compressed into one or more QTT objects. The term “QTT domain” as used herein refers to the transformed computational space or computations in which operations are performed on seismic data that has been compressed into one or more QTT objects. Computations performed in the QTT domain achieve significant computation efficiency gains without significant loss of accuracy.

The graphical tensor notation used herein represents tensor operations in diagrammatic form, where circles (or nodes) may represent tensors and lines (or legs) extending from the circles may represent the indices or dimensions of those tensors. In this notation, each leg may correspond to one index of the tensor, with the number of legs indicating the order or dimensionality of the tensor. Operations between tensors, such as tensor contractions or multiplications may be depicted by connecting legs between different tensor nodes. Free legs (those not connected to other tensors) may represent the indices of the resulting tensor after operations are performed. This graphical notation may provide an intuitive visualization of tensor train structures and operations, where the sequential connection of tensor cores along the rank dimensions may become visually apparent through the connected legs between nodes.

Embodiments disclosed herein may describe implementation of seismic modelling conducted entirely in the QTT domain. The methods may be applied to one-dimensional (1D), two-dimensional (2D), and 3D modelling conducted in both time-domain and frequency domain. The acoustic wave equation may be used:

∇²u=(1/c²)(∂²u/∂t²)−w

where u is pressure wavefield, c is acoustic velocity model of the subsurface (which may be homogeneous or spatially varying), t is time, ∇² is Laplacian operator, and w is a source wavelet function. The algorithm is not limited to this specific type of equation and may be implemented with more complex equations such as elastic and anisotropic versions.

For the time domain approach, the wave equation may be discretized by approximating time and spatial derivatives by finite differences with time sampling Δt and spatial sampling h. For QTT domain implementation, an explicit time stepping scheme may be used to compute wavefields at future time steps. The key difference is that the time-stepping procedure operates entirely with QTT tensors.

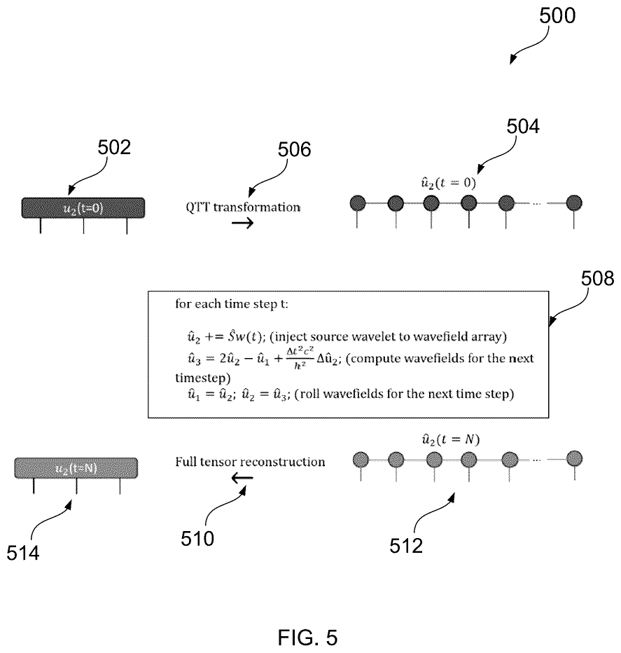

Referring now to FIG. 5 shown is the graphical representation 500 of QTT forward modelling in time domain. Initial seismic data in full domain (u₂(t=0)) 502 is transformed into QTT domain representation (û₂(t=0)) 504 through QTT transformation step 506. For each time step t within a time-stepping loop 508, a source wavelet may be injected to the wavefield array, wavefields for the next timestep may be computed, and wavefields may be rolled for the next time step. Finally, full tensor reconstruction step 510 may transform the computed wavefield array from QTT domain (û₂(t=N)) 512 back to full domain (u₂(t=N)) 514.

The QTT transformation step 506 may apply the quantization and TT-SVD algorithm to convert full domain wavefield data 502 into compressed QTT representation 504. This transformation may reduce the storage requirements significantly while preserving the essential characteristics of the wavefield to a specified accuracy. The time-stepping loop 508 may implement the explicit finite-difference scheme entirely in QTT domain by performing wavefield propagation through multiple time steps without reverting to full domain representation. The full tensor reconstruction step 510 may convert the final QTT wavefield 512 back to full domain format 514 for further processing or output to other analysis tools.

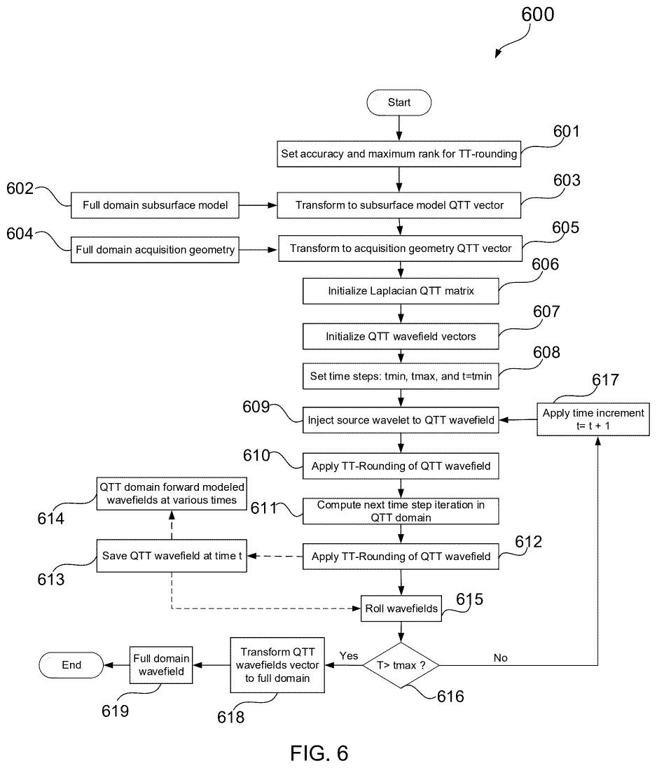

Referring now to FIG. 6, shown is a flowchart of an embodiment of a method 600 for time domain forward modeling using QTT according to various embodiments described herein. At least some, if not all, of the steps of method 600 shown in FIG. 6 may be executed by the computing system 60 shown in FIG. 4, although it may be understood that at least some of the steps of method 600 may be executed by systems other than computing system 60. Additionally, it may be understood that the seismic wavefields described by method 600 may be used for a variety of purposes, including volumetric analysis and in the planning hydrocarbon exploration, which would extend through the subsurface region. Thus, method 600 may be used in the process of generating final seismic data including final migrated seismic data, which may include, for example, final migrated seismic gathers and/or one or more final stacked seismic images of the subsurface region. The final seismic data/models generated by method 600 may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

The method 600 may begin at step 601. At step 601, accuracy and maximum rank parameters for tensor train rounding (TT-rounding) may be set. These parameters may define the compression level and numerical precision throughout the computation. The accuracy parameter may control how closely the compressed QTT representation approximates the full domain data, while the maximum rank parameter may limit the size of the QTT cores to maintain computational efficiency.

At step 602, a full domain subsurface model may be obtained. The full domain subsurface model may represent the physical properties of the subsurface region, such as acoustic velocity, density, reflectivity, or anisotropic parameters models, in conventional array format. At step 603, the full domain subsurface model may be transformed into a subsurface model QTT vector. This transformation may apply quantization and TT-SVD algorithms to compress the subsurface model into QTT format, reducing storage requirements while preserving essential information.

At step 604, full domain acquisition geometry may be obtained. The acquisition geometry may define the spatial locations of seismic sources and receivers used in the survey. At step 605, QTT domain masks or weights may be created based on the acquisition geometry These masks or weights may define spatial weighting functions in QTT representation that identify source and receiver locations for efficient injection and extraction operations during wave equation simulations. The masks or weights may be computed in full domain and then transformed to QTT domain. Alternatively, delta functions may be used for specific locations, or linear combinations of delta functions may be used to form complex weights or masks.

At step 606, a Laplacian QTT matrix may be initialized by defining the Laplacian operator as a sparse QTT matrix. The Laplacian operator may be used to compute spatial derivatives in the wave equation. In QTT domain, the Laplacian operator may be represented as a QTT matrix that has a particularly compact representation with rank limited to 2 for standard second-order derivatives, though the rank may be higher for higher-order derivatives or specialized boundary conditions, providing computational advantages when computing spatial derivatives. This initialized Laplacian QTT matrix may then be multiplied with QTT vector wavefields to compute the spatial derivatives needed for wave equation simulations.

At step 607, QTT wavefield vectors may be initialized. These vectors may represent the pressure wavefield at initial time conditions. The initialization may set up the wavefield arrays in QTT format for subsequent time-stepping computations.

At step 608, time parameters may be set, including minimum time (tmin), maximum time (tmax), and current time (t) which may be initialized to tmin. These parameters may define the temporal range over which the wavefield propagation may be computed.

At step 609, a source wavelet may be injected into the QTT wavefield. The source wavelet may represent the seismic energy introduced by the source at the current time step. The injection may be performed directly in QTT domain by adding the source contribution to the appropriate elements of the QTT wavefield vector.

At step 610, TT-rounding may be applied to the QTT wavefield. This recompression operation may reduce the rank of the QTT representation that may have increased during the source injection operation, thereby maintaining computational efficiency while preserving accuracy within the specified tolerance.

At step 611, the next time step iteration may be computed in QTT domain. This computation may implement the finite-difference approximation of the wave equation entirely using QTT objects. The wavefield at the new time step may be calculated using the wavefields from previous time steps and the Laplacian operator, with all operations performed directly in QTT domain without converting to full domain representation.

At step 612, TT-rounding may be applied to the QTT wavefield. This additional rounding operation may ensure that the wavefield representation remains compact after the time-stepping computation.

At step 613, the QTT wavefield at the current time t may be saved. This storage operation may preserve the wavefield for later use in imaging or inversion procedures. The wavefield may be stored in its compressed QTT format, significantly reducing memory requirements compared to full domain storage.

At step 614, the QTT domain forward modeled wavefields at various times may be saved. This step may accumulate and store the complete set of wavefields computed across multiple time steps, maintaining them in compressed QTT format for efficient storage and subsequent use in seismic imaging or analysis workflows.

At step 615, the wavefields may be rolled for the next time step. Rolling the wavefields refers to an array management operation where the wavefield arrays may be cyclically updated so that the wavefield from the current time step becomes the wavefield from the previous time step, and the wavefield from the previous time step becomes the wavefield from the time step before that. This rolling operation may prepare the wavefield arrays for the next iteration of the time-stepping loop by maintaining the temporal sequence of wavefields needed for the finite-difference scheme while reusing memory efficiently.

At decision point 616, the method 600 may determine whether the current time t exceeds the maximum time tmax. If t is not greater than tmax, the method 600 may proceed to step 617. If t exceeds tmax, indicating that the desired temporal range has been covered, the method 600 may proceed to step 618.

At step 617, a time increment may be applied by advancing the current time t by one time step (t=t+1). This may move the computation forward in time to compute the wavefield at the next temporal instant. After incrementing the time, the method 600 may return to step 609 to continue the time-stepping loop.

At step 618, the QTT wavefields vector may be transformed back to full domain. This transformation may reconstruct the complete wavefield array from its compressed QTT representation, making the results available in conventional format for visualization or further processing.

At step 619, the full domain wavefield may be provided as output. This wavefield may represent the final result of the forward modeling computation, showing how seismic waves propagated through the subsurface model over the specified time range.

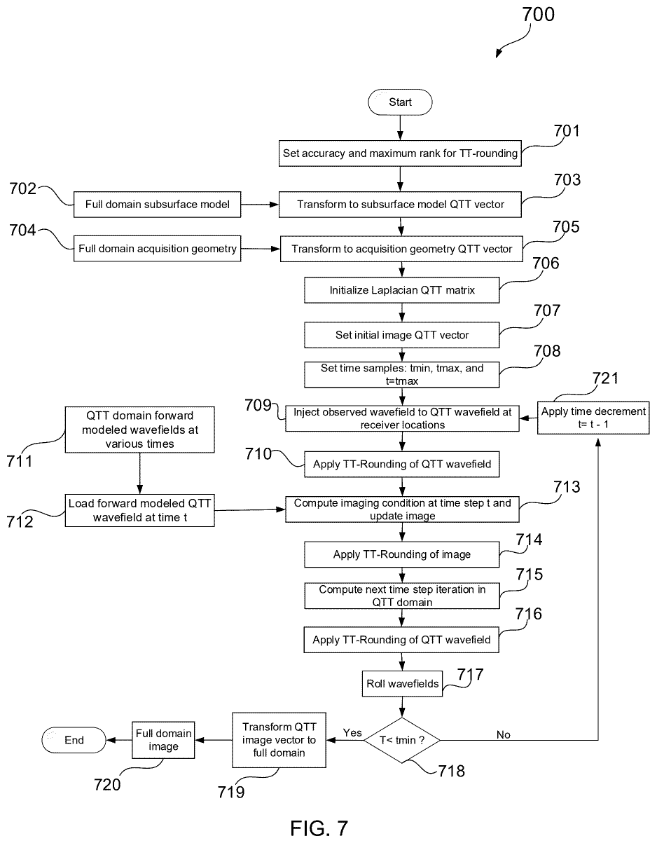

Referring now to FIG. 7, shown is a flowchart of an embodiment of a method 700 for RTM using QTT according to various embodiments described herein. At least some, if not all, of the steps of method 700 shown in FIG. 7 may be executed by the computing system 60 shown in FIG. 4, although it may be understood that at least some of the steps of method 700 may be executed by systems other than computing system 60. Additionally, it may be understood that the seismic images described by method 700 may be used for a variety of purposes, including volumetric analysis and in the planning hydrocarbon exploration, which would extend through the subsurface region. Thus, method 700 may be used in the process of generating final seismic data including final migrated seismic data, which may include, for example, final migrated seismic gathers and/or one or more final stacked seismic images of the subsurface region. The final seismic data/models generated by method 700 may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

At step 701, accuracy and maximum rank parameters for TT-rounding may be set. These parameters may define the compression level and numerical precision throughout the computation. The accuracy parameter may control how closely the compressed QTT representation approximates the full domain data, while the maximum rank parameter may limit the size of the QTT cores to maintain computational efficiency during the reverse time migration process.

At step 702, a full domain subsurface model may be obtained. The full domain subsurface model may represent the physical properties of the subsurface region, such as acoustic velocity or density, in conventional array format. At step 703, the full domain subsurface model may be transformed into a subsurface model QTT vector. This transformation may apply quantization and TT-SVD algorithms to compress the subsurface model into QTT format, reducing storage requirements while preserving essential information for accurate imaging.

At step 704, full domain acquisition geometry may be obtained. The acquisition geometry may define the spatial locations of seismic sources and receivers used in the survey. At step 705, QTT domain masks or weights may be created based on the acquisition geometry. These masks or weights may define spatial weighting functions in QTT representation that identify source and receiver locations for efficient injection and extraction operations during the migration operation. The masks or weights may be computed in full domain and then transformed to QTT domain. Alternatively, delta functions may be used for specific locations, or linear combinations of delta functions may be used to form complex weights or masks.

At step 706, a Laplacian QTT matrix may be initialized. The Laplacian operator may be used to compute spatial derivatives in the wave equation for backward propagation. In QTT domain, the Laplacian operator may have a particularly compact representation with rank limited to 2 for standard second-order derivatives, though the rank may be higher for higher-order derivatives or specialized boundary conditions, providing computational advantages when computing spatial derivatives during the backward migration process.

At step 707, an initial image QTT vector may be set. The initial image QTT vector may represent the starting point for the subsurface image that may be iteratively built up through the imaging condition as the receiver wavefield propagates backward through time.

At step 708, time samples may be set, including minimum time (tmin), middle time (tmid), and maximum time (tmax). These time parameters may define the temporal range over which the backward propagation may be performed. The backward propagation may begin from tmax or tmid and proceed backward in time toward tmin, reversing the direction of wavefield propagation to migrate the recorded seismic data to subsurface image points.

At step 709, an observed wavefield may be injected into the QTT wavefield at receiver locations. The observed wavefield may represent the seismic data recorded by receivers during the seismic survey. The injection may be performed directly in QTT domain by adding the receiver data to the appropriate elements of the QTT wavefield vector corresponding to receiver positions.

At step 710, TT-rounding may be applied to the QTT wavefield. This recompression operation may reduce the rank of the QTT representation that may have increased during the injection operation, thereby maintaining computational efficiency while preserving accuracy within the specified tolerance.

At step 711, QTT domain forward wavefields at various times may be obtained. These forward wavefields may have been computed and stored during a prior forward modeling simulation, representing the source wavefield propagating forward through the subsurface model at multiple time steps. The forward wavefields may be maintained in compressed QTT format for efficient storage and retrieval during the imaging process.

At step 712, a forward modeled QTT wavefield at time t may be loaded. The specific forward wavefield corresponding to the current time step t may be retrieved from the collection of QTT domain forward wavefields obtained in step 711. This wavefield may represent the source energy distribution at time t during forward propagation.

At step 713, an imaging condition at time step t may be computed. The imaging condition may correlate the backward propagated receiver wavefield with the forward propagated source wavefield at the current time step. This correlation may identify locations in the subsurface where the two wavefields are coincident, indicating the presence of reflectors. The imaging condition computation may be performed directly in QTT domain, and the result may be added to the accumulated image vector to build up the subsurface image incrementally.

At step 714, TT-rounding may be applied to the image. This recompression operation may reduce the rank of the image QTT representation that may have increased during the imaging condition computation, thereby maintaining a compact representation while preserving image quality within the specified accuracy tolerance.

At step 715, the next time step iteration may be computed in QTT domain. This computation may implement the finite-difference approximation of the wave equation for backward propagation entirely using QTT objects. The wavefield at the new (earlier) time step may be calculated using the wavefields from subsequent (later) time steps and the Laplacian operator, with all operations performed directly in QTT domain without converting to full domain representation.

At step 716, TT-rounding may be applied to the QTT wavefield. This additional rounding operation may ensure that the wavefield representation remains compact after the backward time-stepping computation.

At step 717, the wavefields may be rolled for the next time step. Rolling the wavefields refers to an array management operation where the wavefield arrays may be cyclically updated so that the wavefield from the current time step becomes the wavefield from the subsequent time step, and the wavefield from the subsequent time step becomes the wavefield from the time step after that. This rolling operation may prepare the wavefield arrays for the next iteration of the backward time-stepping loop by maintaining the temporal sequence of wavefields needed for the finite-difference scheme while reusing memory efficiently.

At decision point 718, the method 700 may determine whether the current time t is less than the minimum time tmin. If t is less than tmin, indicating that the entire temporal range has been covered by backward propagation, the method 700 may proceed to step 719. If t is not less than tmin, the method 700 may proceed to step 721.

At step 719, the QTT image vector may be transformed back to full domain. This transformation may reconstruct the complete subsurface image array from the compressed QTT representation, making the results available in conventional format for visualization or further processing.

At step 720, the full domain image may be output. The full domain image may represent the final migrated subsurface image generated through the RTM process, showing the locations and characteristics of subsurface reflectors that gave rise to the recorded seismic data.

At step 721, a time decrement may be applied by reducing the current time t by one time step (t=t−1). This may move the computation backward in time, which is characteristic of reverse time migration where the receiver wavefield propagates backward from the recording time toward earlier times to image subsurface reflectors. After decrementing the time, the method 700 may return to step 709 to continue the backward time-stepping loop.

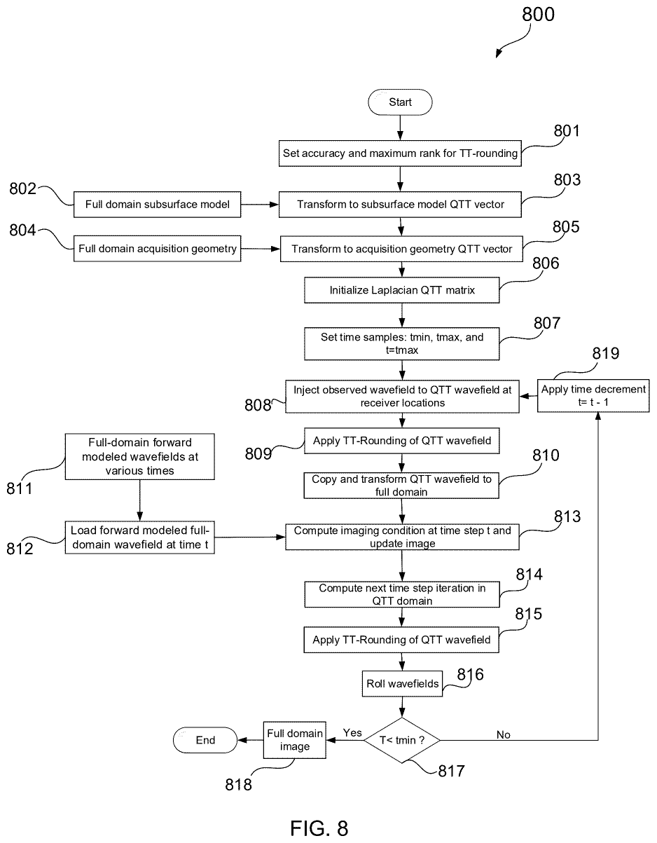

Referring now to FIG. 8, shown is a flowchart of an embodiment of a method 800 for hybrid reverse time migration using quantized tensor trains according to various embodiments described herein. The method 800 may be performed by computing system 60 to generate subsurface images by combining QTT domain backward propagation with full domain imaging condition computation, thereby providing a hybrid approach that balances computational efficiency with imaging flexibility.

At least some, if not all, of the steps of method 800 shown in FIG. 8 may be executed by the computing system 60 shown in FIG. 4, although it may be understood that at least some of the steps of method 800 may be executed by systems other than computing system 60. Additionally, it may be understood that the seismic images described by method 800 may be used for a variety of purposes, including volumetric analysis and in the planning hydrocarbon exploration, which would extend through the subsurface region. Thus, method 800 may be used in the process of generating final seismic data including final migrated seismic data, which may include, for example, final migrated seismic gathers and/or one or more final stacked seismic images of the subsurface region. The final seismic data/models generated by method 800 may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

At step 801, the method 800 includes setting accuracy and maximum rank parameters for TT-rounding. These parameters may define the compression level and numerical precision throughout the computation. The accuracy parameter may control how closely the compressed QTT representation approximates the full domain data, while the maximum rank parameter may limit the size of the QTT cores to maintain computational efficiency during the hybrid reverse time migration process.

At step 802, a full domain subsurface model may be obtained. The full domain subsurface model may represent the physical properties of the subsurface region, such as acoustic velocity or density, in conventional array format. At step 803, the full domain subsurface model may be transformed into a subsurface model QTT vector. This transformation may apply quantization and TT-SVD algorithms to compress the subsurface model into QTT format, reducing storage requirements while preserving essential information for accurate imaging.

At step 804, full domain acquisition geometry may be obtained. The acquisition geometry may define the spatial locations of seismic sources and receivers used in the survey. At step 805, QTT domain masks or weights may be created based on the acquisition geometry. These masks or weights may define spatial weighting functions in QTT representation that identify source and receiver locations for efficient injection and extraction operations during the migration operation. The masks or weights may be computed in full domain and then transformed to QTT domain. Alternatively, delta functions may be used for specific locations, or linear combinations of delta functions may be used to form complex weights or masks.

At step 806, a Laplacian QTT matrix may be initialized. The Laplacian operator may be used to compute spatial derivatives in the wave equation for backward propagation. In QTT domain, the Laplacian operator may have a particularly compact representation with rank limited to 2 for standard second-order derivatives, though the rank may be higher for higher-order derivatives or specialized boundary conditions, providing computational advantages when computing spatial derivatives during the backward migration process.

At step 807, time samples may be set, including minimum time (tmin) and maximum time (tmax), with current time t initialized to tmax. These time parameters may define the temporal range over which the backward propagation may be performed. The backward propagation may begin from tmax and proceed backward in time toward tmin, reversing the direction of wavefield propagation to migrate the recorded seismic data to subsurface image points.

At step 808, an observed wavefield may be injected into the QTT wavefield at receiver locations. The observed wavefield may represent the seismic data recorded by receivers during the seismic survey. The injection may be performed directly in QTT domain by adding the receiver data to the appropriate elements of the QTT wavefield vector corresponding to receiver positions.

At step 809, TT-rounding may be applied to the QTT wavefield. This recompression operation may reduce the rank of the QTT representation that may have increased during the injection operation, thereby maintaining computational efficiency while preserving accuracy within the specified tolerance.

At step 810, the QTT wavefield may be copied and transformed to full domain. This transformation may reconstruct the wavefield from the compressed QTT representation into conventional array format, enabling the imaging condition computation to be performed in full domain where greater flexibility may be available for implementing complex imaging operators.

At step 811, full-domain forward modeled wavefields at various times may be obtained. These forward wavefields may have been computed and stored during a prior forward modeling simulation, representing the source wavefield propagating forward through the subsurface model at multiple time steps. The forward wavefields may be maintained in full domain format for direct use in the imaging condition computation.

At step 812, a forward modeled full-domain wavefield at time t may be loaded. The specific forward wavefield corresponding to the current time step t may be retrieved from the collection of full-domain forward wavefields obtained in step 811. This wavefield may represent the source energy distribution at time t during forward propagation.

At step 813, an imaging condition at time step t may be computed and the image may be updated. The imaging condition may correlate the backward propagated receiver wavefield with the forward propagated source wavefield at the current time step, both in full domain representation. This correlation may identify locations in the subsurface where the two wavefields are coincident, indicating the presence of reflectors. The imaging condition result may be added to the accumulated image to build up the subsurface image incrementally. This hybrid approach may be particularly beneficial for target-oriented imaging applications, where subsurface images may be used in specific regions of interest rather than throughout the entire survey volume. By maintaining wavefields in QTT domain during propagation and converting to full domain for selective imaging condition computation, the method may recover full tensors only at points of interest where the imaging condition is evaluated, rather than requiring full domain representation at all spatial locations. This selective recovery may provide significant computational and memory advantages for target-oriented imaging workflows and time-lapse (4D) seismic monitoring applications, where changes in specific subsurface zones may be the primary focus.

At step 814, the next time step iteration may be computed in QTT domain. This computation may implement the finite-difference approximation of the wave equation for backward propagation entirely using QTT objects. The wavefield at the new (earlier) time step may be calculated using the wavefields from subsequent (later) time steps and the Laplacian operator, with all operations performed directly in QTT domain without converting to full domain representation.

At step 815, TT-rounding may be applied to the QTT wavefield. This additional rounding operation may ensure that the wavefield representation remains compact after the backward time-stepping computation.

At step 816, the wavefields may be rolled for the next time step. Rolling the wavefields refers to an array management operation where the wavefield arrays may be cyclically updated so that the wavefield from the current time step becomes the wavefield from the subsequent time step, and the wavefield from the subsequent time step becomes the wavefield from the time step after that. This rolling operation may prepare the wavefield arrays for the next iteration of the backward time-stepping loop by maintaining the temporal sequence of wavefields needed for the finite-difference scheme while reusing memory efficiently.

At decision point 817, the method 800 may determine whether the current time t is less than the minimum time tmin. If t is less than tmin, indicating that the entire temporal range has been covered by backward propagation, the method 800 may proceed to step 818. If t is not less than tmin, the method 800 may proceed to step 819.

At step 818, the full domain image may be output. The full domain image may represent the final migrated subsurface image generated through the hybrid reverse time migration process, showing the locations and characteristics of subsurface reflectors that gave rise to the recorded seismic data.

At step 819, a time decrement may be applied by reducing the current time t by one time step (t=t−1). This may move the computation backward in time, which is characteristic of reverse time migration where the receiver wavefield propagates backward from the recording time toward earlier times to image subsurface reflectors. After decrementing the time, the method 800 may return to step 808 to continue the backward time-stepping loop.

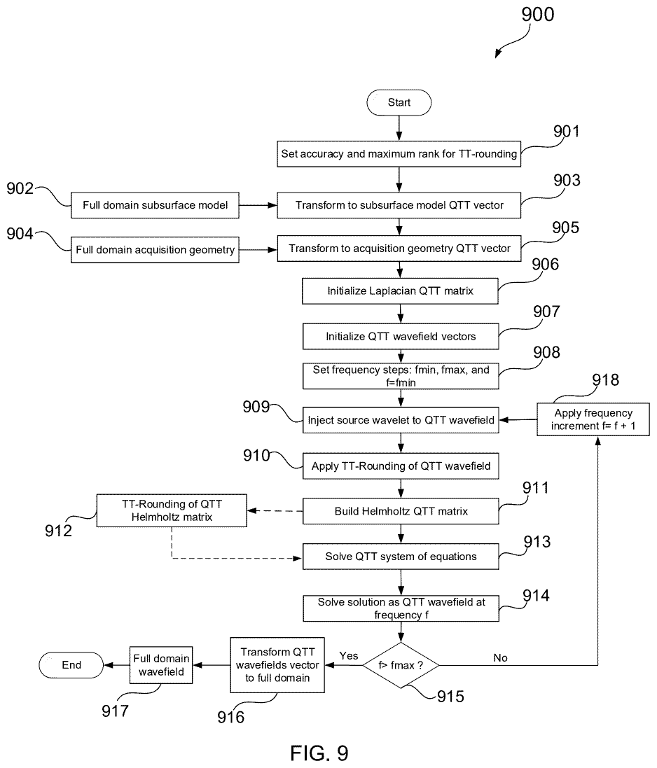

Referring now to FIG. 9, shown is a flowchart of an embodiment of a method 900 for frequency domain forward modeling using QTT according to various embodiments described herein. The method 900 may be performed by computing system 60 to compute seismic wavefields in the frequency domain using QTT representation, thereby enhancing computational efficiency for applications where frequency domain solutions are advantageous, such as FWI or attenuation analysis.

At least some, if not all, of the steps of method 900 shown in FIG. 9 may be executed by the computing system 60 shown in FIG. 4, although it may be understood that at least some of the steps of method 900 may be executed by systems other than computing system 60. Additionally, it may be understood that the seismic images described by method 900 may be used for a variety of purposes, including volumetric analysis and in the planning hydrocarbon exploration, which would extend through the subsurface region. Thus, method 900 may be used in the process of generating final seismic data including final migrated seismic data, which may include, for example, final migrated seismic gathers and/or one or more final stacked seismic images of the subsurface region. The final seismic data/models generated by method 900 may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

At step 901, accuracy and maximum rank parameters for TT-rounding may be set. These parameters may define the compression level and numerical precision throughout the computation. The accuracy parameter may control how closely the compressed QTT representation approximates the full domain data, while the maximum rank parameter may limit the size of the QTT cores to maintain computational efficiency during the frequency domain forward modeling process.

At step 902, a full domain subsurface model may be obtained. The full domain subsurface model may represent the physical properties of the subsurface region, such as acoustic velocity or density, in conventional array format. At step 903, the full domain subsurface model may be transformed into a subsurface model QTT vector. This transformation may apply quantization and TT-SVD algorithms to compress the subsurface model into QTT format, reducing storage requirements while preserving essential information for accurate wavefield computation.

At step 904, full domain acquisition geometry may be obtained. The acquisition geometry may define the spatial locations of seismic sources and receivers used in the survey. At step 905, QTT domain masks or weights may be created based on the acquisition geometry. These masks or weights may define spatial weighting functions in QTT representation that identify source and receiver locations for efficient injection and extraction operations during the frequency domain simulation. The masks or weights may be computed in full domain and then transformed to QTT domain. Alternatively, delta functions may be used for specific locations, or linear combinations of delta functions may be used to form complex weights or masks.

At step 906, a Laplacian QTT matrix may be initialized. The Laplacian operator may be used to compute spatial derivatives in the Helmholtz equation, which governs wave propagation in the frequency domain. In QTT domain, the Laplacian operator may have a particularly compact representation with rank limited to 2 for standard second-order derivatives, though the rank may be higher for higher-order derivatives or specialized boundary conditions, providing computational advantages when constructing the Helmholtz matrix.

At step 907, QTT wavefield vectors may be initialized. These vectors may represent the pressure wavefield in the frequency domain at initial conditions. The initialization may set up the wavefield arrays in QTT format for subsequent frequency domain computations.

At step 908, frequency parameters may be set, including minimum frequency (fmin), maximum frequency (fmax), and current frequency (f) which may be initialized to fmin. These parameters may define the frequency range over which the wavefield solutions may be computed. Frequency domain modeling may solve the Helmholtz equation independently at each frequency of interest.

At step 909, a source wavelet may be injected into the QTT wavefield. The source wavelet may represent the seismic energy introduced by the source at the current frequency. The injection may be performed directly in QTT domain by adding the source contribution to the appropriate elements of the QTT wavefield vector corresponding to source locations.

At step 910, TT-rounding may be applied to the QTT wavefield. This recompression operation may reduce the rank of the QTT representation that may have increased during the source injection operation, thereby maintaining computational efficiency while preserving accuracy within the specified tolerance.

At step 911, a Helmholtz QTT matrix may be built. The Helmholtz equation represents the wave equation in the frequency domain and may be expressed as a linear system of equations. The Helmholtz matrix may incorporate the Laplacian operator, the subsurface model properties, and the angular frequency to form a QTT matrix that relates the wavefield to the source term. Building the Helmholtz matrix in QTT format may provide significant computational and storage advantages compared to full domain representation.

At step 912, TT-rounding may be applied to the Helmholtz matrix. This recompression operation may reduce the rank of the Helmholtz QTT matrix that may have increased during construction, thereby maintaining a compact representation while preserving the accuracy of the operator within the specified tolerance.

At step 913, a QTT system of equations may be solved. This step may solve the linear system defined by the Helmholtz QTT matrix to obtain the wavefield solution at the current frequency. The solution may be computed using iterative solvers adapted for QTT format, such as QTT-adapted conjugate gradient or GMRES methods, which may operate directly on QTT objects without converting to full domain representation.

At step 914, the wavefield solution may be saved. The wavefield solution at the current frequency f may be stored in compressed QTT format, preserving the frequency domain wavefield for later use in imaging, inversion, or analysis procedures while maintaining efficient storage.

At decision point 915, the method 900 may determine whether the current frequency f exceeds the maximum frequency fmax. If f is greater than fmax, indicating that the desired frequency range has been covered, the method 900 may proceed to step 916. If f is not greater than fmax, the method 900 may proceed to step 918.

At step 916, the QTT wavefields vector may be transformed back to full domain. This transformation may reconstruct the complete wavefield arrays from the compressed QTT representation, making the frequency domain results available in conventional format for visualization, interpretation, or further processing.

At step 917, the full domain wavefields may be output. The full domain wavefields may represent the final results of the frequency domain forward modeling computation, showing the wavefield solutions across the computed frequency range.

At step 918, a frequency increment may be applied by advancing the current frequency f by one frequency step (f=f+Δf). This may move the computation to the next frequency value in the specified range. After incrementing the frequency, the method 900 may return to step 909 to continue the frequency-stepping loop and solve for the wavefield at the next frequency.

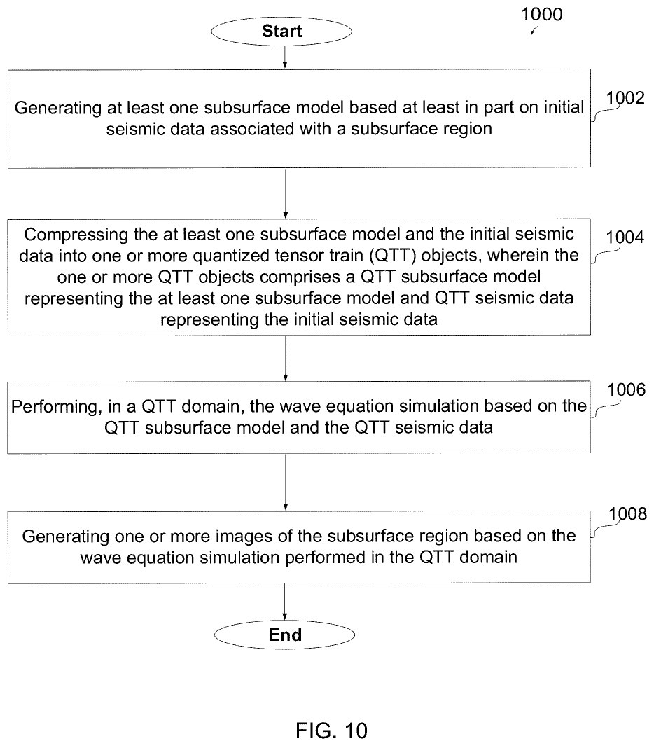

Referring now to FIG. 10, shown is a flowchart of an embodiment of a method 1000 for enhancing computational efficiency of wave equation based simulations using quantized tensor trains according to various embodiments described herein. The method 1000 may be performed to generate subsurface images with reduced computational cost and memory requirements compared to conventional full domain approaches. The wave equation simulations described by method 1000 may be used for volumetric analysis and hydrocarbon exploration planning. The method 1000 may generate seismic images of the subsurface region that may be used to identify subterranean features of interest such as hydrocarbon deposits.

At step 1002, method 1000 comprises generating at least one subsurface model based at least in part on initial seismic data associated with a subsurface region. The subsurface model may represent physical properties of the subsurface region, such as acoustic velocity or density. The initial seismic data may be acquired through seismic surveys and may include recorded waveforms from seismic receivers.

At step 1004, method 1000 comprises compressing the at least one subsurface model and the initial seismic data into one or more QTT objects. The one or more QTT objects may comprise a QTT subsurface model representing the at least one subsurface model and QTT seismic data representing the initial seismic data. The compression process may apply quantization and TT-SVD algorithms to transform full domain arrays into compact QTT representations. The TT-SVD algorithm may decompose multidimensional arrays into a sequence of lower-dimensional core tensors. By setting appropriate accuracy parameters and maximum rank limits, the QTT representation may achieve significant compression while maintaining essential information. The compression into QTT objects may reduce memory requirements compared to storing full domain arrays.

At step 1006, method 1000 comprises performing, in a QTT domain, the wave equation simulation based on the QTT subsurface model and the QTT seismic data. The wave equation simulation may be performed entirely using QTT objects without converting back to full domain representation during the computation. The simulation may implement time domain forward modeling using explicit finite-difference time-stepping schemes or frequency domain forward modeling by solving sparse systems of equations directly in QTT domain. TT-rounding operations may be applied during the simulation to maintain compact QTT representations. The wave equation simulation in QTT domain may provide computational efficiency advantages.

At step 1008, method 1000 comprises generating one or more images of the subsurface region based on the wave equation simulation performed in the QTT domain. The images may be generated by applying imaging conditions to the wavefields computed during the wave equation simulation. After the imaging operations are complete in QTT domain, the image may be transformed back to full domain representation for visualization and analysis. The generated images may provide visualization of subsurface structures including geological formations and potential hydrocarbon reservoirs. The images generated by method 1000 may be used for geological interpretation and hydrocarbon exploration planning.

Referring now to FIGS. 11A-11C, shown are comparison results illustrating the performance of QTT forward modeling compared to conventional full domain forward modeling for a central slice of 3D model according to various embodiments described herein. These figures demonstrate that QTT-based wave equation simulations may achieve comparable accuracy to full domain simulations while providing significant computational efficiency advantages.

Turning first to FIG. 11A, a full domain wavefield snapshot is shown for a central slice of 3D model at a specific time step during forward modeling. In this wavefield snapshot, the X-axis represents the horizontal spatial dimension measured in samples, while the Z-axis represents the vertical spatial dimension, also measured in samples. The variations in shading represents the amplitude of the wavefield, ranging from approximately −0.0010 to 0.0010, with variations in color indicating the pressure or displacement values of the seismic wave at different spatial locations. The wavefield snapshot may be computed using full domain finite-difference time-stepping methods that solve the wave equation on the complete spatial grid without compression. The wavefield patterns visible in FIG. 11A may show the propagation of seismic waves through the subsurface model, including wave fronts, reflections from subsurface interfaces, and interference patterns resulting from wave interactions. This full domain computation may serve as a reference solution against which the QTT-based approach may be compared to assess accuracy and computational efficiency.

Now referring to FIG. 11B, a QTT wavefield snapshot is shown for the same central slice of 3D model at the same time step as shown in FIG. 11A. The QTT wavefield snapshot may be computed entirely in QTT domain using the compressed tensor train representation of the wavefield arrays and operators. The X-axis and Z-axis represent the same spatial dimensions as in FIG. 11A, measured in samples, and the variations in shading maintains the same amplitude range from approximately −0.0010 to 0.0010 for direct comparison. The wavefield patterns in FIG. 11B may closely match those in FIG. 11A, demonstrating that the QTT-based forward modeling approach may accurately reproduce the wave propagation physics despite operating on compressed representations. The visual similarity between the full domain wavefield snapshot and the QTT wavefield snapshot may confirm that the QTT compression maintains the essential wavefield information while reducing memory requirements and computational cost. Any differences between the two wavefields may be minimal and within acceptable accuracy tolerances established by the QTT compression parameters, such as the maximum rank and accuracy settings used during TT-rounding operations.

Referring to FIG. 11C, a timestep runtime comparison is shown, illustrating the computational time involved in each time step iteration during the forward modeling process. In this comparison plot, the X-axis represents the timestep number, ranging from 0 to 256, corresponding to the progression of the time-stepping simulation from initial time to final time. The Y-axis represents the computational time in seconds required to complete each individual timestep. Two curves may be shown in the plot: a first curve representing the full domain timestep runtime and a second curve representing the QTT timestep runtime. The full domain curve may show relatively constant or slightly increasing runtime per timestep, reflecting the computational cost of updating the complete wavefield arrays using conventional finite-difference methods. The QTT curve may show significantly lower runtime per timestep compared to the full domain approach, demonstrating the computational efficiency advantages of performing wave equation simulations in compressed QTT domain. The runtime reduction achieved by the QTT approach may result from the reduced dimensionality of QTT cores compared to full domain arrays and the favorable scaling properties of QTT arithmetic operations. The timestep runtime comparison may demonstrate that QTT-based forward modeling may provide substantial computational speedup while maintaining accuracy comparable to full domain methods, making QTT approaches particularly attractive for large-scale seismic simulations where computational cost may be a limiting factor.

Referring now to FIGS. 12A-12C, shown are comparison results illustrating the performance of QTT forward modeling compared to full domain forward modeling for a 3D subsurface model according to various embodiments described herein. These figures demonstrate that QTT-based wave equation simulations may scale effectively to three-dimensional problems while maintaining accuracy and achieving substantial computational efficiency advantages.

Turning first to FIG. 12A, a full domain wavefield snapshot is shown for a 3D subsurface model at a specific time step during forward modeling. In this wavefield snapshot, the X-axis represents the horizontal spatial dimension measured in samples, ranging from 0 to 1024 samples, while the Z-axis represents the vertical spatial dimension, also measured in samples and ranging from 0 to 1024 samples. The displayed slice may represent a two-dimensional cross-section through the three-dimensional wavefield volume. The variations in shading represents the amplitude of the wavefield, ranging from approximately −0.0010 to 0.0010, with variations in color indicating the pressure or displacement values of the seismic wave at different spatial locations. The wavefield snapshot may be computed using conventional full domain finite-difference time-stepping methods that solve the three-dimensional wave equation on the complete spatial grid without compression. The larger spatial dimensions compared to the central slice of 3D model example shown in FIGS. 11A-11C may illustrate that three-dimensional seismic simulations require substantially greater computational resources and memory in full domain approaches. The wavefield patterns visible in FIG. 12A may show the propagation of seismic waves through the three-dimensional subsurface model, including wave fronts, reflections, and complex interference patterns resulting from three-dimensional wave interactions.

Now referring to FIG. 12B, a QTT wavefield snapshot is shown for the same 3D subsurface model at the same time step as shown in FIG. 12A. The QTT wavefield snapshot may be computed entirely in QTT domain using the compressed tensor train representation of the three-dimensional wavefield arrays and operators. The X-axis and Z-axis represent the same spatial dimensions as in FIG. 12A, measured in samples and ranging from 0 to 1024 samples, and the variations in shading maintains the same amplitude range from approximately −0.0010 to 0.0010 for direct comparison. The wavefield patterns in FIG. 12B may closely match those in FIG. 12A, demonstrating that the QTT-based forward modeling approach may accurately reproduce the three-dimensional wave propagation physics despite operating on compressed representations. The visual similarity between the full domain wavefield snapshot and the QTT wavefield snapshot may confirm that the QTT compression maintains the essential wavefield information even for large-scale three-dimensional problems. The compression advantages of QTT may be particularly significant for three-dimensional simulations where the memory requirements of full domain arrays may scale cubically with the linear dimension of the model. Any differences between the two wavefields may be minimal and within acceptable accuracy tolerances established by the QTT compression parameters.

Referring to FIG. 12C, a timestep runtime comparison is shown, illustrating the computational time required for each time step iteration during the three-dimensional forward modeling process. In this comparison plot, the X-axis represents the timestep number, ranging from 0 to 256, corresponding to the progression of the time-stepping simulation. The Y-axis represents the computational time in seconds required to complete each individual timestep. Two curves may be shown in the plot: a first curve representing the full domain timestep runtime and a second curve representing the QTT timestep runtime. The full domain curve may show substantially higher runtime per timestep compared to the case shown in FIG. 11C, reflecting the increased computational cost of three-dimensional wave equation simulations. The QTT curve may show significantly lower runtime per timestep compared to the full domain approach, demonstrating substantial computational efficiency advantages. The runtime reduction achieved by the QTT approach may be even more pronounced for three-dimensional problems than for two-dimensional problems, as the favorable scaling properties of QTT operations may provide greater benefits when applied to higher-dimensional arrays. The timestep runtime comparison may demonstrate that QTT-based forward modeling may enable practical three-dimensional seismic simulations that might otherwise be computationally prohibitive using conventional full domain methods, making QTT approaches particularly valuable for large-scale three-dimensional exploration and reservoir characterization applications.

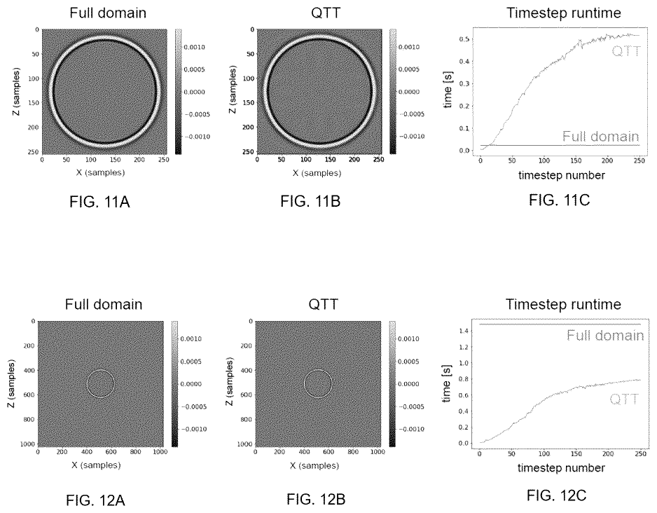

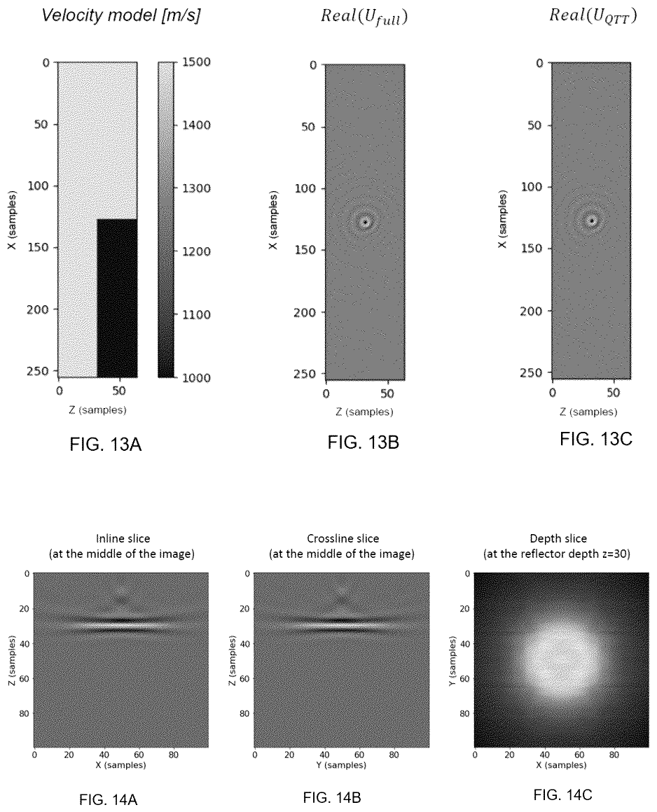

Referring now to FIGS. 13A-13C, shown are comparison results illustrating the performance of QTT frequency domain forward modeling compared to conventional full domain frequency domain forward modeling for a central slice of 3D subsurface model according to various embodiments described herein. These figures demonstrate that QTT-based frequency domain simulations may accurately solve the Helmholtz equation while providing computational efficiency advantages.

Turning first to FIG. 13A, a velocity model is shown representing a central slice of 3D subsurface model used for frequency domain forward modeling. In this velocity model, the X-axis represents the horizontal spatial dimension measured in samples, ranging from 0 to 64 samples, while the Z-axis represents the vertical spatial dimension measured in samples, ranging from 0 to 256 samples. The variations in shading represents the acoustic velocity in meters per second (m/s), ranging from approximately 1000 m/s to 1500 m/s. The velocity model may display variations in subsurface properties, with different colors indicating regions of different seismic velocities. The velocity model may include features such as layered structures, velocity gradients, or velocity perturbations that represent geological formations. This velocity model may serve as the input subsurface model for both the full domain and QTT frequency domain forward modeling simulations, enabling direct comparison of the two approaches on identical subsurface structure.

Now referring to FIG. 13B, the real part of the full domain frequency domain wavefield is shown. In this wavefield snapshot, the X-axis and Z-axis represent the same spatial dimensions as in FIG. 13A, measured in samples. The displayed wavefield may represent the real component of the complex-valued pressure or displacement field computed by solving the Helmholtz equation at a specific frequency using conventional full domain methods. The wavefield patterns may show the spatial distribution of the seismic wave at the selected frequency, including wave propagation, reflections from velocity interfaces, and interference patterns. The full domain solution may be computed by constructing and solving the full Helmholtz matrix system of equations, which may require substantial memory and computational resources, particularly for large-scale problems. This full domain frequency domain wavefield may serve as a reference solution for assessing the accuracy of the QTT-based frequency domain approach.

Referring to FIG. 13C, the real part of the QTT frequency domain wavefield is shown. In this wavefield snapshot, the X-axis and Z-axis represent the same spatial dimensions as in FIGS. 13A and 13B, measured in samples. The displayed wavefield may represent the real component of the complex-valued pressure or displacement field computed by solving the Helmholtz equation in QTT domain at the same frequency as shown in FIG. 13B. The QTT solution may be computed by constructing the Helmholtz operator in QTT matrix format and solving the resulting QTT system of equations using iterative solvers adapted for tensor train representations. The wavefield patterns in FIG. 13C may closely match those in FIG. 13B, demonstrating that the QTT-based frequency domain approach may accurately reproduce the frequency domain wave propagation physics despite operating on compressed representations. The visual similarity between the full domain wavefield and the QTT wavefield may confirm that QTT compression maintains the essential wavefield information for frequency domain simulations. The QTT approach may provide significant advantages for frequency domain forward modeling by reducing the memory requirements for storing the Helmholtz operator and enabling efficient iterative solution methods that operate directly in compressed QTT format, making frequency domain simulations more practical for large-scale applications such as FWI or attenuation analysis.

Referring now to FIGS. 14A-14C, shown are different slices through a 3D RTM image generated using QTT based imaging according to various embodiments described herein. These figures demonstrate that QTT-based reverse time migration may produce high-quality 3D subsurface images showing reflector structures from multiple perspectives.

Turning first to FIG. 14A, an inline slice through the three-dimensional RTM image is shown, taken at the middle of the image volume. In this inline slice, the X-axis represents the horizontal spatial dimension measured in samples, ranging from 0 to 100 samples, while the Z-axis represents the vertical spatial dimension measured in samples, also ranging from 0 to 100 samples. The variations in shading in the image may represent the reflectivity or imaging amplitude at different subsurface locations, with brighter or more intense colors indicating stronger reflections. The inline slice may reveal the vertical and lateral structure of subsurface reflectors along the inline direction. The image may show layered structures, dipping reflectors, or other geological features that have been successfully imaged through the QTT-based reverse time migration process. This inline view may provide information about subsurface structure along a vertical plane oriented in the X-Z direction through the center of the three-dimensional survey volume.

Now referring to FIG. 14B, a crossline slice through the three-dimensional RTM image is shown, also taken at the middle of the image volume. In this crossline slice, the Y-axis represents the horizontal spatial dimension perpendicular to the inline direction, measured in samples and ranging from 0 to 100 samples, while the Z-axis represents the vertical spatial dimension measured in samples, also ranging from 0 to 100 samples. The crossline slice may reveal the vertical and lateral structure of subsurface reflectors along the crossline direction, providing a perpendicular view to the inline slice shown in FIG. 14A. The image patterns may show how the subsurface reflectors vary in the Y-Z plane, capturing geological features and structural elements from this orthogonal perspective. The crossline view may complement the inline view by providing additional spatial information about the three-dimensional geometry of subsurface structures. Together with the inline slice, the crossline slice may enable comprehensive understanding of the three-dimensional subsurface architecture.

Referring to FIG. 14C, a depth slice through the three-dimensional RTM image is shown, taken at the reflector depth z=30 samples. In this depth slice, the X-axis represents the horizontal spatial dimension in the inline direction, ranging from 0 to 100 samples, while the Y-axis represents the horizontal spatial dimension in the crossline direction, also ranging from 0 to 100 samples. This horizontal slice may provide a map view of the subsurface reflector at the specified depth level. The depth slice may reveal the lateral continuity and spatial distribution of the reflector in the horizontal plane, showing features such as structural trends, lateral variations in reflectivity, or discontinuities that may indicate faulting or other geological features. The depth slice may be particularly valuable for interpreting the areal extent and character of geological formations at a specific depth of interest. Together, the three orthogonal slices shown in FIGS. 14A-14C may provide comprehensive three-dimensional visualization of the subsurface structure imaged through QTT-based reverse time migration, demonstrating that the QTT approach may successfully generate high-quality 3D seismic images suitable for geological interpretation and hydrocarbon exploration applications.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for enhancing computational efficiency of a wave equation based simulation, the method comprising:
(a) generating at least one subsurface model based at least in part on initial seismic data associated with a subsurface region;
(b) compressing the at least one subsurface model and the initial seismic data into one or more quantized tensor train (QTT) objects, wherein the one or more QTT objects comprises a QTT subsurface model representing the at least one subsurface model and QTT seismic data representing the initial seismic data;
(c) performing, in a QTT domain, the wave equation simulation based on the QTT subsurface model and the QTT seismic data; and
(d) generating one or more images of the subsurface region based on the wave equation simulation performed in the QTT domain.

2. The method of claim 1, wherein (c) comprises:
(c1) determining, in the QTT domain, one or more gradients using the QTT subsurface model and the QTT seismic data;
(c2) iteratively updating, in the QTT domain, the QTT subsurface model using the one or more gradients;
(c3) determining, in the QTT domain, residual data by comparing synthetic data produced by the QTT subsurface model with the QTT seismic data; and
(c4) migrating, in the QTT domain, the residual data backwards through time to determine the one or more gradients.

3. The method of claim 2, further comprising forward modeling, in the QTT domain, the QTT subsurface model to generate the synthetic data.

4. The method of claim 1, wherein (d) comprises:
(d1) selecting a final QTT subsurface model based on a predefined threshold; and
(d2) generating one or more images of the subsurface region using the final QTT subsurface model.

5. The method of claim 1, further comprising:
(e) recompressing the one or more QTT objects by rounding computed values at each computational step based on the initial seismic data.

6. The method of claim 4, wherein (d2) comprises decompressing the final QTT subsurface model to generate the one or more images of the subsurface region in full domain.

7. The method of claim 5, wherein time domain computations comprise solving the wave equation using explicit finite-difference time-stepping method with the QTT seismic data.

8. The method of claim 7, wherein frequency domain computations comprise solving the wave equation using an implicit finite-difference method to solve a sparse system of equations defined directly in the QTT domain.

9. The method of claim 1, wherein the wave equation comprises acoustic wave equation, elastic wave equation, and anisotropic extensions thereof.

10. A system comprising:
a storage device configured to store instructions; and
one or more processors coupled to the storage device, wherein when executed by the one or more processors, the instructions cause the system to:
(a) generate at least one subsurface model based at least in part on initial seismic data associated with a subsurface region;
(b) compress the at least one subsurface model and the initial seismic data into one or more quantized tensor train (QTT) objects, wherein the one or more QTT objects comprises a QTT subsurface model representing the at least one subsurface model and QTT seismic data representing the initial seismic data;
(c) perform, in a QTT domain, a wave equation simulation based on the QTT subsurface model and the QTT seismic data; and
(d) generate one or more images of the subsurface region based on the wave equation simulation performed in the QTT domain.

11. The system of claim 10, wherein the instructions, when executed by the one or more processors, further cause the system to:
(c1) determine, in the QTT domain, one or more gradients using the QTT subsurface model and the QTT seismic data;
(c2) iteratively update, in the QTT domain, the QTT subsurface model using the one or more gradients;
(c3) determine, in the QTT domain, residual data by comparing synthetic data produced by the QTT subsurface model with the QTT seismic data; and
(c4) migrate, in the QTT domain, the residual data backwards through time to determine the one or more gradients.

12. The system of claim 11, wherein the instructions, when executed by the one or more processors, further cause the system to forward model, in the QTT domain, the QTT subsurface model to generate the synthetic data.

13. The system of claim 10, wherein the instructions, when executed by the one or more processors, further cause the system to:
(d1) select a final QTT subsurface model based on a predefined threshold; and
(d2) generate one or more images of the subsurface region using the final QTT subsurface model.

14. The system of claim 10, wherein the instructions, when executed by the one or more processors, further cause the system to:
(e) recompress the one or more QTT objects by rounding computed values at each computational step based on the initial seismic data.

15. The system of claim 13, wherein (d2) comprises decompressing the final QTT subsurface model to generate the one or more images of the subsurface region in full domain.

16. The system of claim 14, wherein the instructions, when executed by the one or more processors further cause the system to perform time domain computations by solving a wave equation using an explicit finite-difference time-stepping method with the QTT seismic data.

17. The system of claim 15, wherein the instructions, when executed by the one or more processors further cause the system to perform frequency domain computations by solving the wave equation using an implicit finite-difference method to solve a sparse system of equations defined directly in the QTT domain.

18. The system of claim 10, wherein the wave equation comprises acoustic wave equation, elastic wave equation, and anisotropic extensions thereof.

19. A computer program product comprising computer-executable instructions that are stored on a non-transitory computer-readable medium and that, when executed by one or more processors, cause a computing system to:
(a) generating at least one subsurface model based at least in part on initial seismic data associated with a subsurface region;
(b) compressing the at least one subsurface model and the initial seismic data into one or more quantized tensor train (QTT) objects, wherein the one or more QTT objects comprises a QTT subsurface model representing the at least one subsurface model and QTT seismic data representing the initial seismic data;
(c) performing, in a QTT domain, the wave equation simulation based on the QTT subsurface model and the QTT seismic data; and
(d) generating one or more images of the subsurface region based on the wave equation simulation performed in the QTT domain.

20. The computer program product of claim 19, wherein when executed by the one or more processors, further cause the computing system to (e) recompressing the one or more QTT objects by rounding computed values at each computational step based on the initial seismic data.
